(19) United States
(12) Patent Application Publication
(10) Pub. No.: US 2025/0362967 A1
(43) Pub. Date: Nov. 27, 2025

(54) SEMICONDUCTOR DEVICE WITH ARBITRATION SYSTEM

(71) Applicant: Infineon Technologies AG, Neubiberg (DE)

(72) Inventors: Avni Bildhaiya, München (DE); Andreas Graefe, München (DE)

(21) Appl. No.: 19/214,081

(22) Filed: May 21, 2025

(30) Foreign Application Priority Data
May 21, 2024 (DE) 10 2024 204 686.8
May 24, 2024 (DE) 10 2024 204 811.9

(51) Int. Cl. G06F 9/50

(52) U.S. Cl. CPC G06F 9/5038; G06F 9/5044

(57) ABSTRACT

A semiconductor device has a plurality of requesters 10, 12, 14 and a plurality of resources 20, 22. An arbitration system 30 assigns resources to requesters taking into account the fact that some requesters may be able to access only a subset of the resources. A map counter corresponding to each requester may take into account the differing number of resources each requester may use. When a resource becomes available, the resource may be preferentially assigned to a requester with a lower map counter corresponding to a lower number of resources usable by the requester. The map counters of requesters excluded by this test may be decremented to increase their preference when resources next become available. The map counter of requesters allocated a resource may be reinitialized.

### REFERENCE TO RELATED APPLICATION

This application claims priority to German Application number 10 2024 204 811.9, filed on May 24, 2024, which claims priority to German Application number 10 2024 204 686.8, filed on May 21, 2024, the contents of which are hereby incorporated by reference in their entirety.

### TECHNICAL FIELD

The present disclosure relates to a semiconductor device and method for allocating resources to requesters.

### BACKGROUND

In electronic circuits such as microcontrollers or computers there may be a plurality of resources that may be used. Resources may for example include a direct memory access module (DMA), an advanced encryption system engine (AES Engine) or a port. Such resources may be accessed by one of a number of requesters. An arbiter may receive a request for a resource from a requester and assign the resource. In the event that not enough resources are available the arbiter determines which requester gets which resource.

In some cases, certain requesters may only use certain resources. This may be pre-programmed and/or determined by hardware.

There is a need for an arbitration system and method that takes account of the situation that some requesters may only be able to access certain resources.

### SUMMARY

In an example, there is provided a semiconductor device comprising:
a. a plurality of resources for delivering a service;
b. a plurality of requesters requesting access to the plurality of resources, wherein each requester has a predetermined permission to access a permitted set of the resources, wherein the requester may send a request message with a request to access a resource;
c. a network connecting the plurality of resources and the plurality of requesters; and
d. an arbitration system, for allocating resources to requesters,
e. further comprising a map counter corresponding to each of the plurality of requesters, wherein the arbitration system is configured to initialize the map counter with a representation of the number of resources in the permitted set of resources, and when a resource becomes available to preferentially allocate a requester having a respective map counter indicating a lower number of resources in the permitted set.

In this way, those requesters, which are only permitted to use a lower number of resources, are given priority. This avoids the situation that when some requesters can only use a limited number of resources, when one of those resources becomes available the resource is assigned to a requester with a large number of permitted resources rather than a small number, so that the requester only permitted to access a smaller number of resources has to then wait a long time for one of the small number of resources it is permitted to use to become available.

In examples, the arbitration system and map counter are implemented in hardware as a separate block or blocks, not as software running on a core using main memory.

In examples, the arbitration system is configured, when a resource becomes available:
to preferentially allocate a requester having a respective map counter indicating a lower number of resources in the permitted set; and
to adjust the map counter of the requester as a non-preferentially allocated requester corresponding to non-preferentially allocated resources to indicate a lower number of resources, and
wherein the arbitration system is configured, when a used resource previously used by a requester becomes available, to:
re-initialize the map counter of the used resource with a representation of the number of resources in the permitted set of resources.

In this way, the map counter of requesters which are able to use a large number of resources are initially set to disadvantage those requesters in the arbiter, favoring requesters, which can only use a limited number of resources. However, each time they are passed over for resource access as a result, the map counter is adjusted to improve their priority. This ensures that requesters permitted to use a large number of resources are not permanently disadvantaged and do get a turn. When the requester does get a turn using the resource, the map counter is re-initialized.

The method therefore balances the need to give a higher priority to requesters, which can only use a limited number of resources, so that when a resource they can use becomes available, it is assigned with priority to the requester with the need to avoid blocking requesters, which can use many resources.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a semiconductor device;

FIG. 2 illustrates a resource allocation system;

FIG. 3 is a flow diagram illustrating the use of the resource allocation system;

FIG. 4 illustrates a resource allocation system;

FIG. 5 illustrates a use case; and

FIG. 6 illustrates a further system.

### DETAILED DESCRIPTION

The examples described herein describe a semiconductor device.

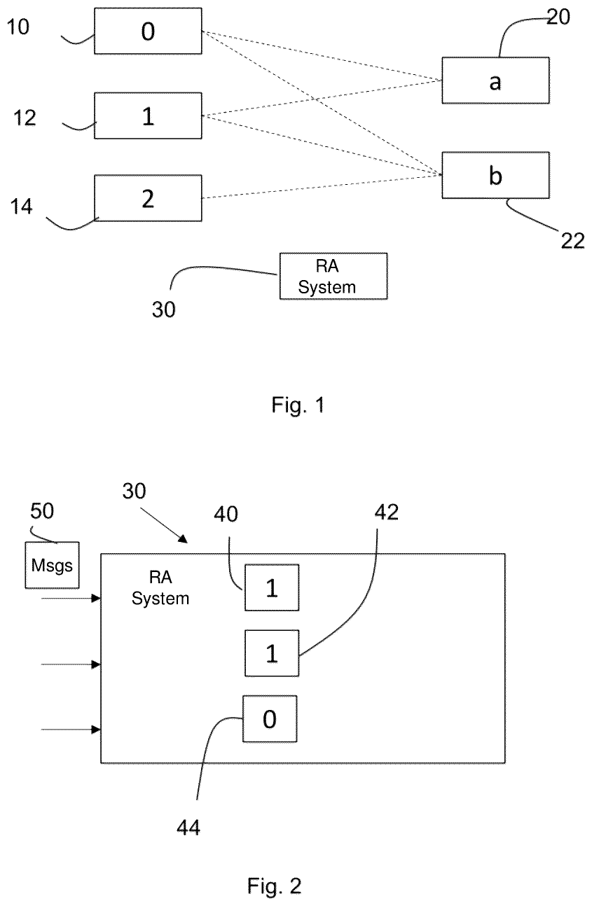

FIG. 1 shows a semiconductor device having a plurality of active requesters 10, 12, 14, which will be referred to as requester 0 (10), requester 1 (12) and requester 2 (14). There are also a plurality of resources 20, 22, which will be referred to as resource a (20) and resource b (22). Each active requester 10, 12, 14 may require access to one or more resources 20, 22. In order to do this, a resource allocation (RA) system or an arbitration system 30 may assign requesters 10, 12, 14 to resources 20, 22. A requester can be a client device, computer, processor(s), processing circuitry or other processing device communicatively coupled to or connected to the semiconductor device, the resource allocation system 30 and one or more resources 20, 22. Requesters can include one or more transistors in processing circuitry comprising one or more processors with input terminals and output terminals configured to communicate with the resource allocation system 30 and one or more resources 20, 22, for example. Likewise, the resource allocation system 30 can include one or more transistors in processing circuitry comprising one or more processors with input terminals and output terminals configured to communicate with the requesters 10, 12, 14 and one or more resources 20, 22, for example. A network 18 connects the requesters 10, 12, 14 to assigned resources 20, 22.

In some cases, not all resources may be used by all requesters. For example, consider the case that requester 0 and requester 1 can use either of resource a or resource b, but requester 2 can only use resource b.

Consider the case when the resource allocation system simply takes turns in a round robin approach. In this case, when resource a becomes available then it could be allocated to requester 0 and when resource b becomes available it could be allocated to requester 1. If the next resource to become available is resource a, then it would be the turn of requester 2, but requester 2 is not able to use resource a. In other words, the round robin approach, which does not take into account the fact that not all resources may be used by all requesters, can lead to considerable delays in allocating resources to some requesters.

Accordingly, as shown in FIG. 2, the resource allocation system 30 may comprise one or more map counters 40, 42, 44 associated with each of the resources. The map counter 40, 42, 44 may represent the number of resources available to the corresponding requester 10, 12, 14. In an example, the map counter 40, 42, 44 may be (re)initialized with the number of resources available to the corresponding requester minus 1. In the example of FIG. 1, requester 0 can access two resources (resource a and resource b) and so the map counter 40 corresponding to requester 0 is (re)initialized with 1. The same applies to requester 1, so map counter 42 is also (re)initialized with 1. Since requester 2 can only use resource b, map counter 44 is (re)initialized with 0.

Those skilled in the art will realize that the way in which the map counter 40, 42, 44 represents the number of resources may be different. For example, the map counters 40, 42, 44 may represent the number of resources plus or minus a constant k. In the example of the previous paragraph, this constant k is 1, but another value may be chosen, including, for example, k=0, so the map counter is initialized to the number of available resources.

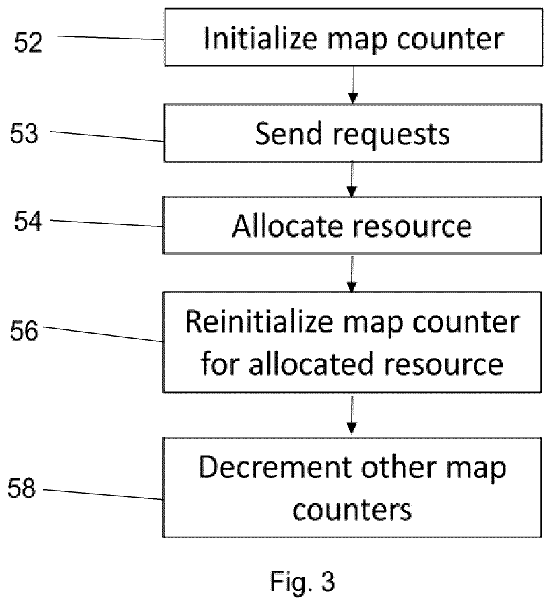

In use, the resource arbitration system 30 may operate as follows, as illustrated in FIG. 3.

Firstly, the map counters 40, 42, 44 are initialized at 52.

In the event that a requester 10, 12, 14 requires a resource it may send at 53 a corresponding message 50 of FIG. 2 to the resource arbitration system 30 requesting a resource. When a resource becomes available, the resource arbitration system may then allocate the resource. In particular, the resource arbitration system may allocate at 54 a resource to the requester with the lowest map counter from among the requesters, which have requested the resource and which are able to use that resource. In the case that more than one requester meets this criterion, then one of the requesters is selected, for example by taking turns.

Where a requester is not allocated a resource as a result of the map counter being too high, the map counter for that requester is decremented at 58 by one. This may avoid resources always being allocated to requesters, which can only use a small number of resources, and hence may achieve a fairer balance between the different requesters. Those skilled in the art will realize that an increment may be used instead of a decrement in an equivalent arrangement.

When a requester is allocated a resource, the map counter for that requester is re-initialized at 56 to the value representing the number of resources available for that requester.

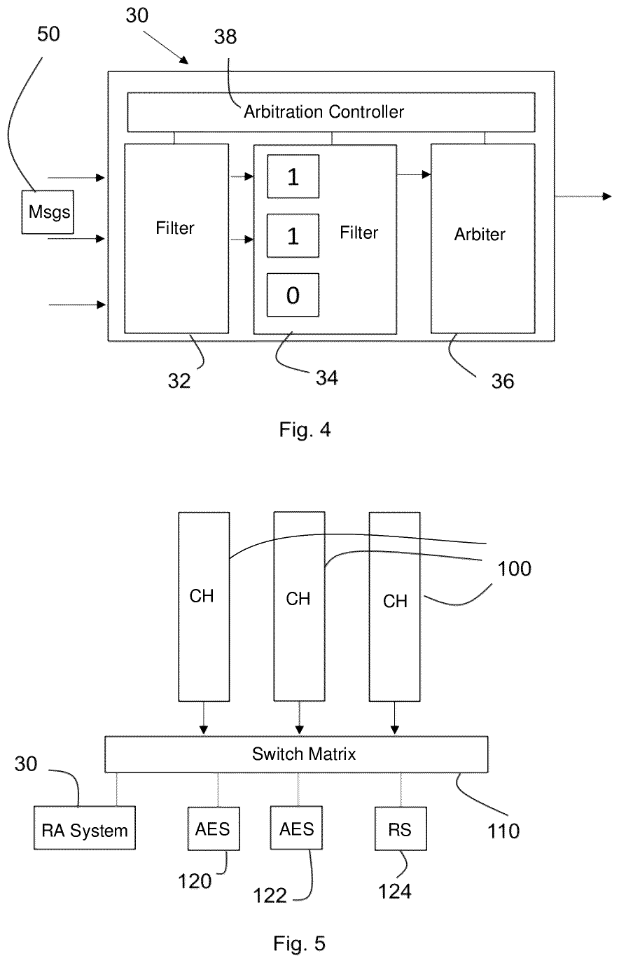

In order that resources can rapidly be allocated to requesters, the resource allocation system may be implemented in hardware, not as code running on a core. FIG. 4 illustrates such a hardware resource allocation system 30 having a first filter 32, a second filter 34 and a round robin arbiter 36. The map counters 40, 42 and 44 of FIG. 2 are allocated to the second filter 34. An arbitration controller 38 (e.g., a processor, microchip, or processing circuitry) is provided connected to each of the first filter 32, second filter 34 and round robin arbiter 36.

In use, a requester 10, 12, 14 requiring use of a resource 20, 22 sends corresponding messages 50 to the resource allocation system 30. When a resource 20, 22 becomes available, the first filter 32 filters out messages unable to use that resource and passes messages from requesters able to use the resource to the second filter 34.

The second filter 34 then selects the requester or requesters 10, 12, 14 with the lowest map counter 40, 42, or 44 from the messages 50 passed through the first filter and passes to arbiter 36. Messages from resources not having the lowest map counter are filtered out, and the map counter corresponding to these resources is decremented by 1.

The arbiter 36 then selects a resource from those having the lowest map counter. In the example described here, this is done using a round robin arbiter in which resources take turns.

Consider the specific example described above with respect to FIG. 1 with requesters 0 and 1 able to use both resources a and b and requester 2 only resource b.

Assuming each requester 10, 12, 14 requests allocation of a resource with a respective message, the resources will be allocated as follows. Firstly, the arbitration controller 38 controls the arbitration system to allocate resource a as follows,

The first resource a can be used by requester 0 and requester 1, but not requester 2. Accordingly, the first filter 32 filters out the message 50 from requester 2 and passes the messages from requester 0 and from requester 1 to the second filter 34.

The map counters 40, 42 and 44 corresponding to requester 0 and requester 1 are both 1. Accordingly, the lowest map counter is 1 and so both messages are passed to arbiter 36. As no messages are filtered out, no map counter is decremented.

Arbiter 36 then selects one of the requesters. Assume requester 0 is selected, then resource a is allocated to requester 0. The map counter 40 corresponding to requester 0 is then reinitialized to 1.

Next, the resource allocation system allocates resource b under control of arbitration controller 38

In this case, requester 0 already has a resource (e.g., resource a) so there remain only messages 50 from both requester 1 and requester 2. Both can use resource b, so both messages pass through the first filter 32.

In this case, the second filter 34 checks the map counter 42, which has the value 1 corresponding to requester 1, and the map counter 44, which has the value 0 corresponding to requester 2. The lowest map counter is accordingly the value 0, and hence only the message corresponding to requester 2 is passed through the second filter to the arbiter 36.

As only the message from requester 2 is passed to arbiter 36, arbiter 36 simply assigns resource b to requester 2.

As the second filter 34 has filtered out the message corresponding to requester 1, the corresponding map counter 42 is decremented and now has the value 0. In this way, requester 1 effectively has a higher priority than requester 0 and the same priority as requester 2 for a subsequent request, which ensures that requester 1 should get the use of the resource the next time either of the resources becomes available.

FIG. 5 shows a particular application of the approach above.

In this case, a plurality of channels (CH) 100 are provided feeding into a switch matrix 110 which connects the channels to a number of resources, including for example AES engines 120, 122. Other, different resources (RS) 124 may also be provided,

Normally, any channel 100 may be able to access any AES engine 120, 122, but in some security related instances a channel can request only odd AES engines or only even AES engines. By providing an arbitration system 30 as illustrated above, insufficient allocation of resources to such channels can be minimized.

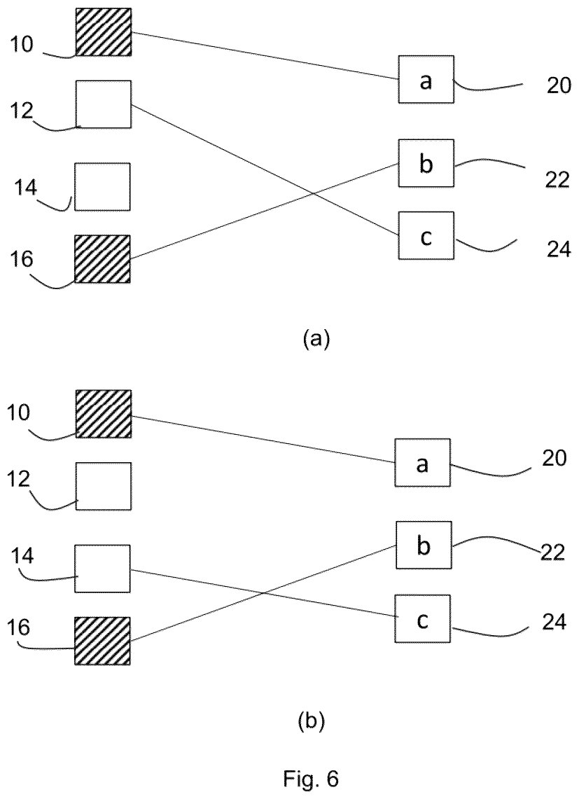

In the example above, all requesters have the same priority. FIG. 6 illustrates a further development in which the different requesters are also allocated different priorities. This can be achieved with a change, specifically in arbiter 36 of FIG. 4, which is no longer a pure round robin arbiter, but which now takes account of priorities.

In this case, consider the case that there are four requesters 10, 12, 14, 16 and three available resources 20, 22, 24 and that the first requester 10 and fourth requester 16 have high priorities.

In a first round (a) the high priority requesters 10, 16 are allocated resources followed by one of the low priority requesters, here requester 12.

In the second round (b), again the high priority requesters 10, 16 are allocated resources, followed by the next low priority requester, here requester 14.

The arbiter 36 cycles through this scheme; in the present example all low priority requesters have now been served so the next round will serve the high priority requesters and then revert to requester 12, starting the repeat of the cycle.

The above approach can allow for a scalable architecture that can be used for different chips in a family. In this case, some “low end” chips in the family may have a limited number of requesters and a limited number of resources and other “high end” chips may have a larger number of requesters and a larger number of resources. The approach proposed above may be simple enough to be implemented in “low end” chips whilst being capable of assigning resources also in more complex “high end” chips allowing a consistent architecture for the whole family.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A semiconductor device comprising:
a plurality of resources each for delivering a respective service;
a plurality of requesters requesting access to the plurality of resources, wherein each requester has a predetermined permission to access a permitted set of resources, wherein a requester sends a request message with a request to access a resource;
a network connecting the plurality of resources and the plurality of requesters;
an arbitration system connected to the network, for allocating the plurality of resources to the plurality of requesters; and
a plurality of map counters each corresponding to one of the plurality of requesters,
wherein the arbitration system is configured to initialize a map counter with a representation of a number of resources in the permitted set of resources, and when the resource becomes available to preferentially allocate a requester having a map counter, respectively, indicating a lower number.

2. The semiconductor device according to claim 1,
wherein the arbitration system is configured, when the resource becomes available:
to preferentially allocate the requester having the map counter; and
to adjust the map counter of the requester as a non-preferentially allocated requester to indicate a lower number of resources, and
wherein the arbitration system is configured, when a used resource previously used by the requester becomes available, to:
re-initialize the map counter corresponding to the requester of the used resource with the representation of the number of resources in the permitted set of resources.

3. The semiconductor device according to claim 1, wherein the arbitration system comprises a map counter filter and an arbiter,
wherein the map counter filter is configured to, when the resource becomes available, and at least one requester requests the resource:
pass through the map counter filter each request message from the at least one requester having the map counter indicating a lowest number of resources in the permitted set of resources from the at least one requester requesting the resource; and
adjust the map counter for non-preferentially allocated resources to indicate a lower number of resources, and
wherein the arbitration system is further configured, when a used resource previously used by the requester becomes available, to:
re-initialize the map counter of the used resource with the representation of the number of resources in the permitted set of resources; and
the arbiter is configure to select one of a plurality of request messages passed through the map counter filter and to allocate the used resource to the at least one requester, respectively.

4. The semiconductor device according to claim 3, wherein each requester has a priority, and the arbiter is configured to select one of the plurality of request messages passed through the map counter filter based on priorities of requesters.

5. The semiconductor device according to claim 3, wherein the arbiter is arranged to select one of the plurality of request messages passed through the map counter filter on a round robin basis.

6. The semiconductor device according to claim 3, wherein:
the representation of the number of resources used when the arbitration system initializes and re-initializes the map counter is the number of resources in the permitted set of resources less a constant.

7. The semiconductor device according to claim 6, wherein the arbitration system is further configured to adjust the map counter of at least one requester corresponding to non-preferentially allocated resources by decrementing the map counter or counters, respectively.

8. The semiconductor device according to claim 7 wherein the map counter filter is configured to pass through each request message from the least one requester having a lowest map counter value from the plurality of requesters requesting the resource.

9. A semiconductor device comprising:
a plurality of resources for delivering a respective service;
a plurality of requesters requiring access to the plurality of resources, wherein each requester has a predetermined permission to access a permitted set of the resources, wherein a requester sends a request message with a request to access a resource;
a network connecting the plurality of resources and the plurality of requesters; and
an arbitration system, for allocating the plurality of resources to the plurality of requesters, connected to the network to receive request messages,
wherein the arbitration system comprises:
a map counter corresponding to each of the plurality of requesters, the arbitration system being arranged to initialize the map counter with a number of resources in the permitted set of resources less a constant;
a first filter for filtering the request messages, such that when a resource becomes available the first filter passes only the request messages configured to use the resource; and
a second filter having an input connected to a filtered output of the first filter for filtering the request messages passing through the first filter by selecting messages from the plurality of requesters having a lowest available map counter,
wherein the arbitration system is configured to decrement the map counter of other requesters filtered out by the second filter.

10. The semiconductor device according to claim 9, wherein the arbitration system is further configured to re-initialize the map counter with the number of resources in the permitted set of resources less the constant when the requester has been allocated a resource.

11. The semiconductor device according to claim 9, wherein the constant is 1.

12. The semiconductor device according to claim 9, further comprising a round robin arbiter connected to an output of the second filter for selecting one of the request messages passed through the second filter.

13. A method of operating a semiconductor device comprising an arbitration system, a plurality of resources each for delivering a respective service and a plurality of requesters requesting access to the plurality of resources, wherein each requester has a predetermined permission to access a permitted set of the resources, and a network connecting the arbitration system, the plurality of requesters and the plurality of resources, the method comprising:
(a) initializing a map counter for each requester with a representation of a number of resources in the permitted set of resources;
(b) sending a request message from a requester to request access to a resource;
(c) repeating the sending of the request message from the requester to request access to the resource; and
(d) when the resource becomes available, preferentially allocating the requester to the resource, the requester allocated the resource having a map counter indicating a lowest number of resources in the permitted set from the plurality of requesters requesting the resource.

14. The method according to claim 13, the method further comprising:
adjusting the map counter of the requester allocated the resource to indicate the lowest number of resources; and
re-initializing the map counter corresponding to the requester, when a used resource previously used by the requester becomes available, with the representation of the number of resources in the permitted set of resources.

15. The method according to claim 13, further comprising:
passing through a map counter filter each request message from the plurality of requesters having the map counter indicating the lowest number of resources in the permitted set of resources;
adjusting the map counter for non-preferentially allocated resources to indicate a lower number of resources;
re-initializing the map counter corresponding to a requester, when a used resource previously used becomes available, with the representation of the number of resources in the permitted set of resources;
selecting one of a plurality of request messages passed through the map counter filter; and
allocating the used resource to at least one other requester.

16. The method according to claim 15, further comprising:
selecting one of the plurality of request messages passed through the map counter filter based on priorities associated with the plurality of requesters.

17. The method according to claim 15, further comprising:
selecting one of the plurality of request messages passed through the map counter filter further based on a round robin basis and priorities associated with the plurality of requesters.

18. The method according to claim 15, wherein:
the representation of the number of resources used when the arbitration system initializes and re-initializes the map counter is the number of resources in the permitted set of resources less a constant.

19. The method according to claim 18, further comprising:
adjusting, via the arbitration system, the map counter of at least one requester corresponding to non-preferentially allocated resources by decrementing one more map counters corresponding to the plurality of requesters.

20. The method according to claim 19, further comprising:
reinitializing the map counter of the at least one requester with the number of resources in the permitted set of resources less one in response to the at least one requester being allocated the resource.
